(19) United States
(12) Patent Application Publication
(10) Pub. No.: US 2026/0181011 A1
(43) Pub. Date: Jun. 25, 2026

(54) LARGE LANGUAGE MODEL-BASED METHOD FOR VULNERABILITY LOCALIZATION

(71) Applicants: BEIHANG UNIVERSITY, Beijing (CN); HANZHOU INNOVATION INSTITUTE OF BEIHANG UNIVERSITY, Hangzhou (CN)

(72) Inventors: Hailong SUN, Beijing (CN); Xiang GAO, Beijing (CN); Wentong TIAN, Beijing (CN)

(73) Assignees: BEIHANG UNIVERSITY, Beijing (CN); HANZHOU INNOVATION INSTITUTE OF BEIHANG UNIVERSITY, Hangzhou (CN)

(21) Appl. No.: 19/432,094

(22) Filed: Dec. 23, 2025

(30) Foreign Application Priority Data
Dec. 24, 2024 (CN) 202411911244.5

(51) Int. Cl. H04L 9/40; H04L 41/16

(52) U.S. Cl. CPC H04L 63/1433; H04L 41/16

(57) ABSTRACT

Disclosed a large language model (LLM)-based method for vulnerability localization, comprising using a tool for vulnerability localization. The method comprises: S1, enhancing vulnerability localization using an information aggregator and a syntax highlighter; S2, bridging a gap between in-domain vulnerability localization and out-of-domain vulnerability localization using an out-of-distribution detection algorithm; S3, making decisions on in-distribution data and out-of-distribution data. The method can improve the accuracy of vulnerability detection, enhance out-of-domain data processing capacity, generalization capacity of the LLM, and reduce false positives and misjudgements of vulnerabilities.

### CROSS-REFERENCE TO RELATED APPLICATIONS

This application claims priority to the Chinese Patent Application No. 202411911244.5, filed on Dec. 24, 2024, the contents of which are hereby incorporated by reference.

### TECHNICAL FIELD

The present disclosure relates to the field of computer program security technology, in particular to a large language model (LLM)-based method for vulnerability localization.

### BACKGROUND

With the rapid development of computer technology and the continuous increase in software scale, software security issues have become increasingly prominent. A software vulnerability is a potential defect existing in a software system. Attackers or malicious actors can exploit the software vulnerability to perform malicious operations, thereby endangering the security of the software system and applications. Due to the significant impact of software vulnerabilities on software security, which may even lead to substantial economic losses. Accordingly, it has become extremely crutial to quickly and effectively locate and fix security vulnerabilities. A vulnerability localization technique can help developers efficiently debug and fix vulnerabilities by precisely identifying source code locations that need to be modified. In recent years, the number of disclosed vulnerabilities has been continuously increasing, which has attracted widespread attention from both academia and industry.

Therefore, it is necessary to provide a large language model (LLM)-based method for vulnerability localization, for effectively locating vulnerability positions and fixing vulnerable code in large-scale source code, reducing human intervention, and improving the efficiency and accuracy of vulnerability detection and localization.

### SUMMARY

One or more embodiments of the present disclosure provide a large language model (LLM)-based method for vulnerability localization, comprising: using a tool for vulnerability localization. The tool for vulnerability localization includes: an information aggregator and a syntax highlighter configured to enhance vulnerability localization, and an algorithm module configured to detect out-of-distribution data. The method comprises: S1, enhancing the vulnerability localization using the information aggregator and the syntax highlighter; wherein firstly, the tool for vulnerability localization inputs a source code after tokenization into an LLM to extract a hidden state containing semantic information; then the information aggregator is configured to integrate all code element information of a single line of code in the source code, and the syntax highlighter is configured to highlight key code elements in the single line of code to determine whether the single line of code contains a vulnerability; S2, bridging a gap between in-domain vulnerability localization and out-of-domain vulnerability localization using an out-of-distribution detection algorithm; wherein in an inference phase, the tool for vulnerability localization employs an out-of-distribution detector configured to evaluate whether the vulnerability falls within a known distribution range of a fine-tuned model, to determine whether the vulnerability is an in-distribution vulnerability; the out-of-distribution detector analyzes and evaluates enhanced line-level representations obtained previously from a fine-tuning training dataset using a K-nearest neighbor algorithm; based on an evaluation result, the tool for vulnerability localization is configured to perform prediction using an enhanced fine-tuned model or perform prediction using a pretrained LLM; and S3, making decisions on in-distribution data and the out-of-distribution data; wherein in response to a vulnerability function falling within the known distribution range, the tool for vulnerability localization is configured to assign the in-distribution data to the fine-tuned model for processing, and finally generate a vulnerability probability for each line of code; otherwise, for the out-of-distribution data, the tool for vulnerability localization is configured to perform inference using the LLM combined with a chain-of-thought (CoT).

Compared with the prior arts, the beneficial effects of the present disclosure include:

### 1. Improving Accuracy of Vulnerability Detection;

The tool for vulnerability localization can comprehensively capture semantic information within and across lines of code through the aggregator and the syntax highlighter, and identify key tokens directly related to vulnerabilities, significantly improving accuracy of vulnerability localization. By effectively filtering redundant information utilizing an adaptive domain mask mechanism, misjudgment can be avoided, and the LLM can be ensured to focus on core factors causing vulnerabilities.

### 2. Enhancing Capability for Processing Out-of-Domain Data;

Through an out-of-distribution (OOD) detection method, the tool for vulnerability localization can effectively distinguish between the in-domain data and the out-of-domain data. For the out-of-domain data, the tool for vulnerability localization can analyze the out-of-domain data using the pre-trained LLM combined with a CoT prompting technique, significantly enhancing capability of the LLM to handle unknown vulnerability types. False positives in code and missed vulnerabilities are reduced, and detection coverage of the LLM for new vulnerability types is improved.

### 3. Improvement in Model Generalization Capability;

By combining the pre-trained LLM and the fine-tuned model, the tool for vulnerability localization possesses stronger adaptability and generalization capability when handling vulnerabilities in different programming languages and application scenarios, which enables the tool for vulnerability localization to be widely applied to cross-domain vulnerability detection tasks, not limited to known distributions in training data.

### 4. Reducing Possibility of False Positives and Misjudgments;

Traditional vulnerability detection models are susceptible to interference from irrelevant code snippets or high-frequency functions, leading to a high false positive rate. However, the tool for vulnerability localization, through the syntax highlighter and the out-of-distribution detection algorithm, focuses on key code elements, and avoids misjudging irrelevant code as vulnerabilities, significantly reducing the false positive rate.

### BRIEF DESCRIPTION OF THE DRAWINGS

The present disclosure is further described by way of exemplary embodiments. The exemplary embodiments are described in detail with reference to the accompanying drawings. These embodiments are not limiting. In these embodiments, the same reference numerals denote the same structures.

FIG. 1 is a module diagram illustrating a large language model (LLM)-based system for vulnerability localization according to some embodiments of the present disclosure;

FIG. 2 is a flowchart illustrating an exemplary large language model (LLM)-based method for vulnerability localization according to some embodiments of the present disclosure;

FIG. 3 is a schematic diagram illustrating an exemplary process for determining whether a code snippet corresponding to test data is in-domain data or out-of-domain data according to some embodiments of the present disclosure;

FIG. 4 is a flowchart illustrating an exemplary process for detection and deployment control of an object to be released according to some embodiments of the present disclosure;

FIG. 5 is a flowchart illustrating an exemplary process for determining clean traffic according to some embodiments of the present disclosure.

### DETAILED DESCRIPTION

To more clearly illustrate the technical solutions in the embodiments of the present disclosure, the accompanying drawings used in the description of the embodiments are briefly introduced below. Obviously, the accompanying drawings in the following description are merely some examples or embodiments of the present disclosure. For those having ordinary skills in the art, the present disclosure may be applied to other similar scenarios based on these accompanying drawings without creative effort. Unless obviously obtained from the context or the context illustrates otherwise, the same numeral in the drawings refers to the same structure or operation.

In existing technologies, common methods for vulnerability localization include spectrum-based localization techniques and mutation-based localization techniques. These techniques primarily determine a vulnerability location by analyzing program execution traces corresponding to a large number of passing test cases and failing test cases. However, a sufficient number of high-quality test cases typically do not exist in practical software systems. Moreover, for observable vulnerabilities, obtaining failing test cases that can trigger the vulnerabilities (i.e., test cases that can trigger vulnerability exploitation) is also a challenge. To avoid reliance on test cases, another direction for vulnerability localization is based on machine learning technologies and deep learning technologies. By leveraging the capabilities of deep learning in automatic feature extraction and software semantic interpretation, methods for vulnerability localization based on machine learning and deep learning have received increasing attention in recent years. Specifically, methods for vulnerability localization based on machine learning technologies and deep learning technologies predict a possibility of a vulnerability existing in a source code snippet by utilizing features generated by a model trained on a defect dataset.

Among methods for vulnerability localization based on machine learning technologies and deep learning technologies, LLM-based methods for vulnerability localization currently achieve the optimal performance. By leveraging the capabilities of LLM in automatic feature extraction and deep semantic interpretation of code, LLM-based methods for vulnerability localization have attracted increasing attention in recent years.

Among the LLM-based methods for vulnerability localization, a large language model with attention optimization (LLMAO) is a method for vulnerability localization that combines an LLM with a bidirectional attention mechanism, aiming to automatically locate vulnerability lines in source code without requiring test coverage information. Existing LLM-based methods for vulnerability localization have some problems. First, due to the sensitivity of security data, vulnerability-related labeled data is limited, which affects the generalization capability of the LLM in practical scenarios. Moreover, fine-tuning of the LLM is costly and may easily cause catastrophic forgetting. Second, the existing methods have insufficient understanding of complex dependency relationships in programs, making it difficult to accurately capture vulnerability-related key details in program code, and failing to effectively distinguish the contribution of different code statements to vulnerabilities. Finally, the LLM may generate seemingly credible but actually erroneous results in some cases, which increases the burden of manual vulnerability verification and reduces the practicality of the methods for vulnerability localization.

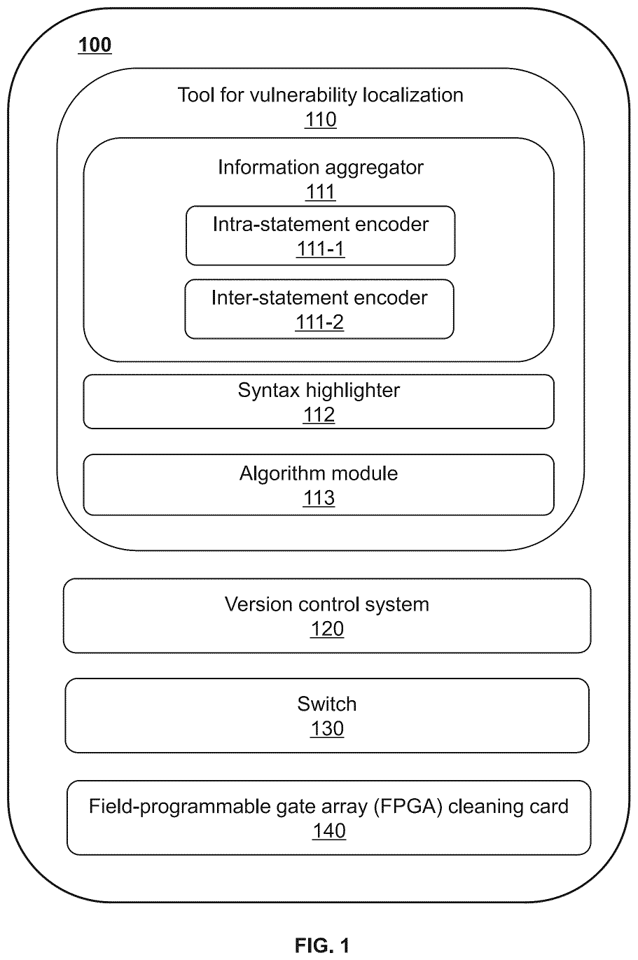

FIG. 1 is a module diagram illustrating a large language model (LLM)-based system for vulnerability localization according to some embodiments of the present disclosure. As shown in FIG. 1, an LLM-based system 100 for vulnerability localization may include a tool for vulnerability localization 110, a version control system 120, a switch 130, and a field-programmable gate array (FPGA) cleaning card 140. In some embodiments, modules shown in FIG. 1 may be implemented by a processing device.

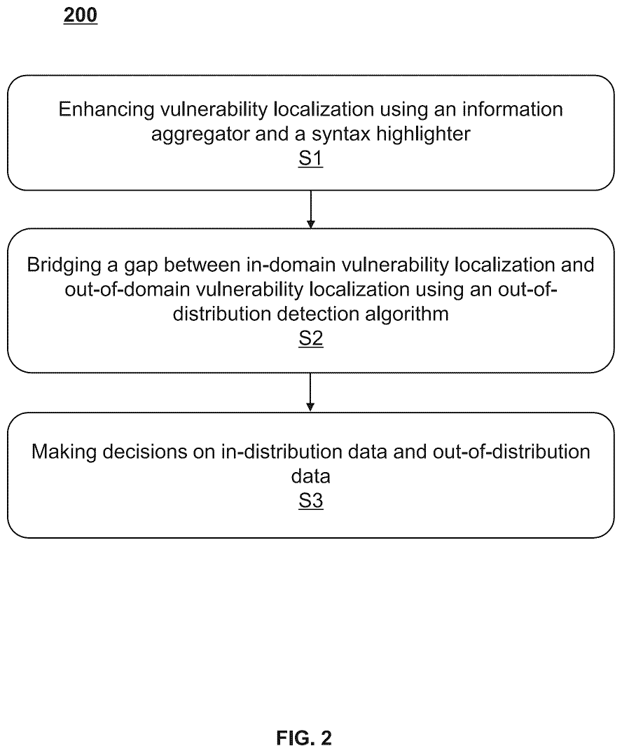

The tool for vulnerability localization 110 refers to a tool for locating vulnerabilities in source code. In some embodiments, based on an evaluation result, the tool for vulnerability localization is configured to perform prediction using an enhanced fine-tuned model or perform prediction using a pre-trained LLM. More descriptions may be found in operation S2 of FIG. 2 and the related descriptions thereof.

As shown in FIG. 1, the tool for vulnerability localization 110 may include an information aggregator 111, a syntax highlighter 112, and an algorithm module 113.

The information aggregator 111 is configured to integrate all code element information of a single line of code in the source code. In the present disclosure, the information aggregator 111 may also be referred to as an aggregator. More descriptions may be found in operation S1 of FIG. 2 and the related descriptions thereof.

As shown in FIG. 1, the information aggregator 111 may include an intra-statement encoder 111-1 and an inter-statement encoder 111-2.

The intra-statement encoder 111-1 is configured to capture dependency relationships among a plurality of code elements within a line of code.

The inter-statement encoder 111-2 is configured to process contextual dependencies between different lines of code to ensure that cross-line semantic information is effectively captured.

In some embodiments, the intra-statement encoder and the inter-statement encoder may be implemented using an encoding network based on a self-attention mechanism, such as a Transformer encoder or bidirectional encoder representations from transformers (BERT)-style encoder. In some embodiments, the intra-statement encoder and the inter-statement encoder are two independent modules. More descriptions may be found in operation S1 of FIG. 2 and the related descriptions thereof.

The syntax highlighter 112 is configured to highlight key code elements in the single line of code to determine whether the single line of code contains a vulnerability. More descriptions may be found in operation S1 of FIG. 2 and the related descriptions thereof.

In some embodiments, the information aggregator 111 and the syntax highlighter 112 may be two separate modules. In some embodiments, the information aggregator 111 and the syntax highlighter 112 may also be integrated into a same module as two functional units.

The algorithm module 113 is configured to detect whether a given code snippet belongs to out-of-distribution data (which may also be referred to as out-of-domain data) using a K-nearest neighbor algorithm. In some embodiments, the algorithm module 113 may be configured as a component of an out-of-distribution detector (which may also be referred to as an out-of-domain data detector). More descriptions may be found in operation S2 and operation S3 of FIG. 2 and the related descriptions thereof.

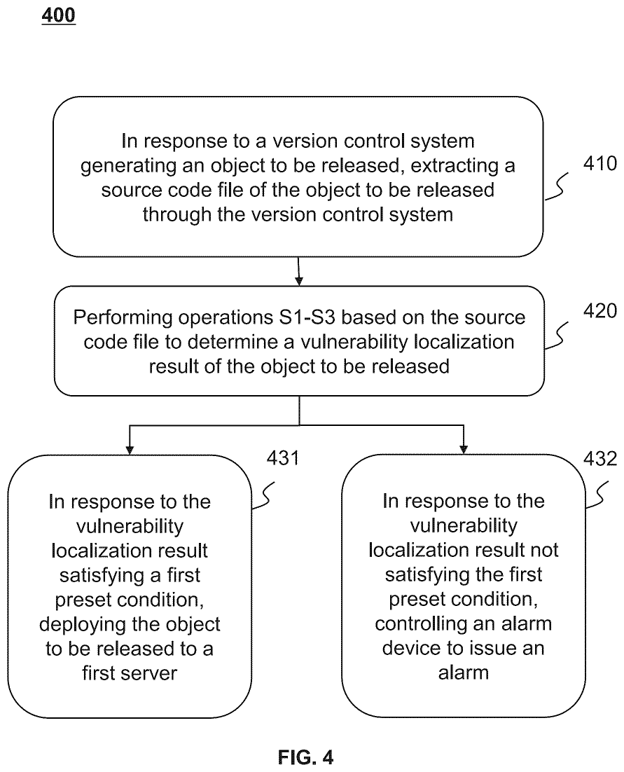

The version control system 120 is configured to manage the source code. In some embodiments, a user may extract a source code file of an object to be released through the version control system 120. More descriptions may be found in operation 410 of FIG. 4 and the related descriptions thereof.

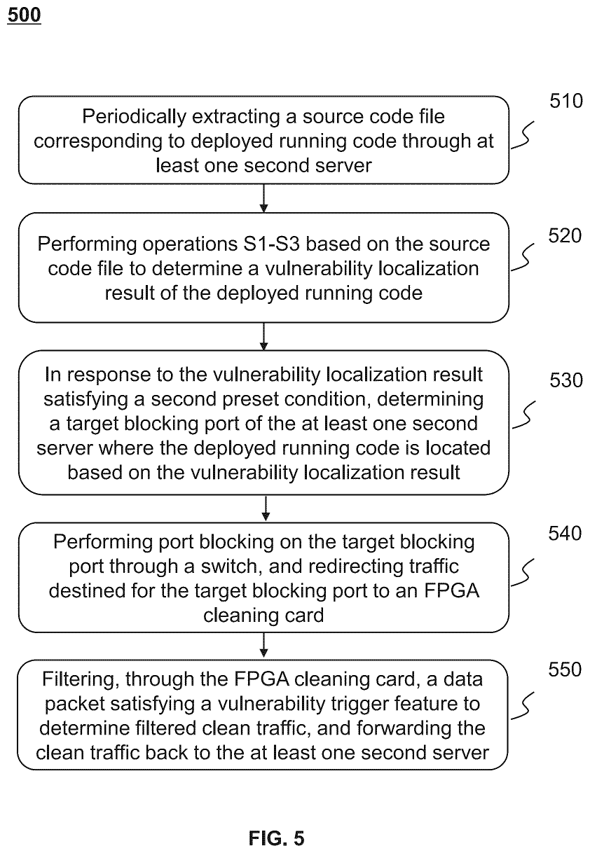

The switch 130 is configured to perform port blocking on a target blocking port and divert traffic flowing to the target blocking port to the FPGA cleaning card. In some embodiments, the switch 130 may be in communication connection to a second server. More descriptions may be found in FIG. 5 and the related descriptions thereof.

The FPGA cleaning card 140 is configured to filter data packets that satisfy a vulnerability trigger feature to determine filtered clean traffic and forward the clean traffic back to the second server. More descriptions may be found in FIG. 5 and the related descriptions thereof.

The processing device may process data and/or information from various components of the LLM-based system 100 for vulnerability localization and/or from external data sources. The processing device may execute program instructions based on the data, the information, and/or processing results, thereby performing one or more functions described in the present disclosure. For example, the processing device may execute a process 200 in FIG. 2. In some embodiments, the processing device may include a computer, or the like. In some embodiments, the processing device may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

FIG. 2 is a flowchart illustrating an exemplary large language model (LLM)-based method for vulnerability localization according to some embodiments of the present disclosure. As shown in FIG. 2, a process 200 includes operations S1-S3. In some embodiments, the process 200 may be executed by the processing device.

In S1, enhancing vulnerability localization using an information aggregator and a syntax highlighter; wherein firstly, a tool for vulnerability localization inputs a source code after tokenization into an LLM to extract a hidden state containing semantic information; then the information aggregator is configured to integrate all code element information of a single line of code in the source code, and the syntax highlighter is configured to highlight key code elements in the single line of code to determine whether the single line of code contains a vulnerability.

The source code refers to an entire software program or code content of a certain function in the software program. The single line of code (also referred to as each line of code) refers to a basic unit constituting a source code statement, i.e., an independent code line separated by a line break or a statement terminator (e.g., a semicolon) in the source code.

The source code after tokenization refers to a token sequence obtained after segmenting the source code. For example, a line of the source code may be represented as “int sum=a+b;”, and after tokenization, the line of the source code may be represented as [“in”, “sum”, “=”, “a”, “+”, “b”, “,”].

In some embodiments, the tool for vulnerability localization may perform tokenization on source code corresponding to a vulnerability function S according to a preset lexical rule to obtain a sequence composed of a plurality of tokens. Each token in the sequence corresponds to a code element (e.g., a keyword, a variable name, or the like) in the source code. The code element refers to a basic element constituting the source code statement, such as a keyword, an identifier (e.g., a variable name, a function name), an operator, a delimiter, or the like.

For example, for the vulnerability function S, the tool for vulnerability localization may analyze the source code of the vulnerability function S and perform tokenization on code elements such as keywords, variable names, operators, statement boundary symbols, and constants in the source code according to a preset lexical rule.

The vulnerability function S may be a function known to contain a vulnerability or a function suspected to contain a vulnerability. The vulnerability function S may be preset according to requirements. For example, in a code snippet sprint (buffer, “Number: % d”, number) in the source code, sprintf represents a function, and buffer, “Number: % d”, number represent parameters passed to the function. The actual cause leading to a potential vulnerability is that a size of number exceeds an allocated memory space of the buffer, thereby causing a buffer overflow. In this case, the sprintf function is regarded as the vulnerability function S.

The semantic information refers to information about meanings, functions of various code elements in the source code, and contextual relationships with surrounding code. The semantic information may include dependency relationships among a plurality of code elements, contextual information between different lines of code, or the like. For example, the semantic information may be represented as follows. The code element “int” indicates that a variable type is an integer. The code element “sum” indicates a variable name for storing an operation result. The code elements “a” and “b” indicate variables participating in an addition operation. The code element “+” indicates performing an arithmetic addition operation on the variable “a” and the variable “b”. The code element “=” indicates assigning the addition operation result to the variable “sum”. As another example, the semantic information may further include contextual dependencies such as a function, a loop structure, or a conditional branch where a line of source code is located, which are used to characterize semantics of the line of code in the entire source code.

In some embodiments, the LLM may include a deep neural network (DNN) model or the like. The LLM may include a plurality of network layers. In some embodiments, the LLM may be pre-trained based on a large amount of code corpus to learn semantic information among different tokens in the source code and generate hidden states containing the semantic information at various network layers.

The hidden states are used to characterize semantic information of code elements corresponding to respective tokens in a context of the entire vulnerability function S.

In some embodiments, the LLM may extract the hidden states containing the semantic information based on the input source code after tokenization. Specifically, the tool for vulnerability localization may input tokens corresponding to the source code after tokenization into the LLM for forward calculation and extract hidden states corresponding to respective tokens at a penultimate layer of the LLM.

In some embodiments, to achieve line-level feature aggregation, the tool for vulnerability localization may perform uniform length processing on tokens corresponding to respective lines of source code. Specifically, for each line of source code, the tool for vulnerability localization may determine a count of tokens included in the line. In response to a determination that the count of tokens included in the line is greater than 64, the tool for vulnerability localization may truncate the count of tokens to retain at most 64 tokens. In response to a determination that the count of tokens is less than 64, the tool for vulnerability localization may pad one or more tokens at an end of the line until the count of tokens of the line is supplemented to 64, thereby obtaining a preliminary feature for representing the line of code and ensuring that a feature length corresponding to each line of code remains consistent.

The code element information refers to attribute information related to a code element. The code element information may include dependency relationships among the plurality of code elements. For example, the dependency relationships may include, but are not limited to, reference relationships among the plurality of code elements, call relationships, type inheritance relationships, package dependency relationships, value transfer relationships between parameters and variables, or the like.

In some embodiments, after obtaining the preliminary feature of each line of code, the tool for vulnerability localization performs line-level feature aggregation and cross-line feature aggregation through the information aggregator. First, an intra-statement encoder is used to capture dependency relationships among the plurality of code elements within each line of code and generate an enhanced line-level representation. Then, an inter-statement encoder is used to capture dependency relationships across lines, especially vulnerability issues that may be caused across lines. Finally, the tool for vulnerability localization further aggregates cross-line contextual information through a Transformer layer and uses a bidirectional attention mechanism to simultaneously capture forward dependency relationships and backward dependency relationships in the source code to overcome limitations of causal attention in the large language model. After the Transformer layer completes encoding, the tool for vulnerability localization performs average pooling on features of each line of code to generate a final line-level representation.

The feature aggregation refers to performing line-level and cross-line integration processing on the code element information in the single line of code and contextual dependencies between different lines of code.

The line-level feature aggregation (also referred to as aggregation at line level) refers to aggregating the plurality of code elements within a same single line of code into a line-level representation of the single line of code. The cross-line feature aggregation refers to integrating line-level representations of a plurality of lines of code based on dependency relationships among the plurality of lines of code. The line-level representation is used to characterize semantic information of each line of code and information related to a vulnerability.

The enhanced line-level representation is used to characterize dependency relationships among the plurality of code elements within each line of code.

In some embodiments, the intra-statement encoder may capture dependency relationships among the plurality of code elements within each line of code based on correlations among hidden states corresponding to respective tokens. The intra-statement encoder may integrate the dependency relationships among the plurality of code elements to generate the enhanced line-level representation, thereby implementing line-level feature aggregation.

In some embodiments, the inter-statement encoder may treat each line of code as a different line element. The inter-statement encoder may determine a correlation between any line of code and other lines of code to capture contextual dependency among cross-line code (also referred to as different code lines), thereby ensuring effective capture of the cross-line contextual information.

The contextual information refers to information representing a relationship between a certain line of code and different lines of code before and after the certain line of code. The contextual information may include cross-line dependency relationships, variable usage relationships, or the like.

The forward dependency relationship refers to a semantic or data dependency relationship of a certain line of code on preceding lines of code. The backward dependency relationship refers to a semantic or data dependency relationship of a certain line of code on subsequent lines of code.

In some embodiments, the tool for vulnerability localization may encode enhanced line-level representations of respective lines of code through an encoding layer based on a Transformer structure. The tool for vulnerability localization may treat each line of code as a sequence of line-level representations arranged in a source code order. The tool for vulnerability localization may utilize the bidirectional attention mechanism to determine a correlation between a line-level representation corresponding to any line of code and line-level representations corresponding to other lines of code before and after any line of code, thereby capturing the forward dependency relationships and the backward dependency relationships in the source code.

In some embodiments, after the Transformer layer completes encoding, the tool for vulnerability localization may perform pooling processing on features of each line of code to generate the corresponding final line-level representation, thereby implementing cross-line feature aggregation.

The final line-level representation is used to represent deep semantic information of each line of code for detecting a potential vulnerability in the source code. The deep semantic information (also referred to as a deep semantic representation) is used to reflect semantic information of the line of code within an overall context of the source code. The deep semantic information includes dependency relationships with other lines of code, contextual association relationships, semantic information that may cause a vulnerability, or the like.

In some embodiments of the present disclosure, the intra-statement encoder captures dependency relationships among the plurality of code elements within each line of code, and the intra-statement encoder integrates the dependency relationships into an enhanced line-level representation, such that the line-level representation not only includes the semantic information of a single token but also incorporates semantic connections among the code elements within the same single line of code. The inter-statement encoder processes contextual dependency among different lines of code, effectively introducing cross-line semantic information into a representation of a corresponding line. In particular, the inter-statement encoder can capture a vulnerability issue caused jointly by a plurality of lines of code, thereby compensating for a deficiency of insufficient contextual information when analysis is performed based solely on the single line of code. By using the Transformer layer to further aggregate the cross-line contextual information, and utilizing the bidirectional attention mechanism to simultaneously capture the forward dependency relationships and the backward dependency relationships in the source code, limitations of causal attention in the LLM can be overcome, making the final line-level representation comprehensively reflect semantic associations between the single line of code and the plurality of lines of code before and after the single line of code.

Although line-level feature aggregation and cross-line feature aggregation can be effectively implemented through the information aggregator and the Transformer layer in the tool for vulnerability localization, in practical applications, each line of code typically includes a large number of tokens, among which only a portion of tokens are directly associated with generation of the vulnerability. Presence of a large number of unrelated tokens may cause interference to the LLM during the generation of line-level representations, reducing the accuracy of vulnerability detection. Therefore, the tool for vulnerability localization may further select and highlight tokens directly related to the vulnerability, namely key code elements, to reduce interference and improve the accuracy of vulnerability detection.

The key code element refers to a code element within the single line of source code that is directly associated with the generation of the vulnerability or has a significant impact on a vulnerability determination result.

In some embodiments, the syntax highlighter in the tool for vulnerability localization may highlight the key code elements in the single line of code to determine whether the single line of code includes the vulnerability. Specifically, an implementation manner of the syntax highlighter includes two steps: decisive feature selection and decisive token selection. Because the source code has complexity, for example, a same identifier in the source code may have a plurality of meanings in different contexts, the LLM of the tool for vulnerability localization is prone to generating spurious features during the learning process. The spurious features cause output vectors to include a large count of redundant and irrelevant values, affecting determination of the LLM. Therefore, the decisive feature selection and the decisive token selection are required to remove the spurious features.

The spurious feature refers to a feature in the source code that is unrelated to the vulnerability. For example, in a code snippet sprintf (buffer, “Number: % d”, number) in source code, an actual cause of the potential vulnerability is that a size of number exceeds a memory allocation space of buffer, leading to a buffer overflow risk. However, during the learning process of the LLM, because a function sprintf appears with high frequency in a large count of code, the LLM may erroneously regard the function as the vulnerability, tending to consider that any code line using the function may include the vulnerability, while ignoring key tokens that truly cause the vulnerability, such as buffer size and parameter values. Therefore, for any code line using the sprintf function, features corresponding to code unrelated to the buffer overflow risk may serve as the spurious features. This indicates that the LLM is prone to interference from the spurious features during the learning process, misjudging unrelated code snippets (e.g., the sprintf function) as vulnerabilities. Therefore, the tool for vulnerability localization needs to perform further selection on tokens, suppressing code elements unrelated to the vulnerability and retaining only tokens closely related to the vulnerability, namely key code elements, to determine whether the single line of code includes the vulnerability.

The decisive feature refers to a feature, among feature representations of the plurality of tokens in the source code, that is related to the vulnerability and has a key impact on a vulnerability detection result. In the present disclosure, the hidden state may be regarded as the feature representation.

In some embodiments, the syntax highlighter in the tool for vulnerability localization may design an adaptive domain mask to select decisive token features, further eliminating code elements unrelated to the vulnerability. The adaptive domain mask is a learnable mask. The adaptive domain mask may be represented as a mask vector acting on each dimension of a feature representation of the token. Each mask element in the adaptive domain mask may adaptively learn and adjust during a training process. After training converges, the adaptive domain mask tends to exhibit a form approximating binary elements, i.e., some mask elements have zero values, and some mask elements have non-zero values. The mask vector obtained after training converges may be regarded as the mask vector learned by the adaptive domain mask. For example, when the adaptive domain mask adopts a binary element form, element values of the adaptive domain mask may be 0 or 1. In some embodiments, the adaptive domain mask may also adopt a weight mask form. Element values of the adaptive domain mask may be 0, serving as the zero values; or element values of the adaptive domain mask may be learnable weights greater than 0, serving as the non-zero values.

Specifically, the syntax highlighter in the tool for vulnerability localization may apply the adaptive domain mask to the hidden state of each token. The syntax highlighter may perform element-wise multiplication of the adaptive domain mask with the feature representation of each token to select decisive features. For example, when a mask element in the adaptive domain mask has a zero value, a product result is also close to 0, indicating that a corresponding token feature no longer has an impact in subsequent vulnerability determination. Therefore, mask elements with values close to 0 may be used to filter the spurious features or unnecessary information in token embeddings. When the mask element has a non-zero value, the product result can still retain an effective numerical value, thereby retaining and highlighting features related to the vulnerability as decisive features. The unnecessary information refers to redundant features, features unrelated to the vulnerability, invalid features, and the spurious features present in the token hidden state or the token embedding.

In some embodiments, after completing the decisive feature selection within tokens, the syntax highlighter in the tool for vulnerability localization may further perform selection among the plurality of tokens based on the attention mechanism. Specifically, after completing the decisive feature selection, the plurality of tokens corresponding to decisive features may serve as a token set. The syntax highlighter may compare and select respective tokens in the set through the attention mechanism to select a most decisive token.

The decisive token refers to a token, among the plurality of tokens, that has a key impact on the vulnerability detection result. The decisive token corresponds to a code element carrying the decisive feature. In some embodiments, the syntax highlighter may highlight or mark the code element corresponding to the decisive token as a key code element, used to indicate a location related to the vulnerability.

In some embodiments, after completing the decisive feature selection, the syntax highlighter in the tool for vulnerability localization may process a feature representation of each token retained after the decisive feature selection based on the attention mechanism to select the decisive token.

Specifically, first, the syntax highlighter in the tool for vulnerability localization uses the hidden states of the plurality of tokens (i.e., feature representations of the tokens) as key vectors in the attention mechanism. The syntax highlighter uses the mask vector learned by the adaptive domain mask as a query vector. The syntax highlighter calculates an association degree between the plurality of key vectors and the query vector to generate a corresponding attention score. The attention score is used to measure an association between each token and vulnerability-related knowledge and characterize a magnitude of contribution of each token to vulnerability detection. The vulnerability-related knowledge refers to information related to vulnerability generation that the LLM gradually learns during the training process.

In some embodiments, for each vulnerability type, the syntax highlighter in the tool for vulnerability localization may use the mask vector corresponding to the vulnerability type as the query vector to represent a domain feature of the vulnerability type. Based on the attention score generated from the mask vector, the LLM may automatically identify code tokens unrelated to the vulnerability and suppress the code tokens, thereby enabling the LLM to focus more on code tokens with higher attention scores for the vulnerability type and corresponding code snippets that may cause the vulnerability.

In some embodiments, the syntax highlighter in the tool for vulnerability localization may multiply the attention score and the feature representation of the token to obtain a highlighted token feature representation as a decisive token for representing a token directly related to the vulnerability.

In some embodiments of the present disclosure, through the decisive feature selection, the tool for vulnerability localization may perform the element-wise multiplication between the adaptive domain mask and the token feature representation, enabling the zero values in the mask to effectively filter out the spurious features in the token embeddings, while the non-zero values highlighting key vulnerability-related features. Thus, while invalid features are eliminated, decisive features related to the vulnerability can be retained and highlighted, thereby improving vulnerability identification capability and accuracy. Further, through the decisive token selection, the tool for vulnerability localization may select decisive tokens based on attention scores and suppress code tokens with lower attention scores that are unrelated to the vulnerability, focusing on code tokens that contribute more to the vulnerability detection and corresponding code elements, thereby further improving accuracy of the vulnerability detection. Thus, omission of important information by the LLM when processing a large count of code lines is avoided, and precise identification of key code snippets where the vulnerability occurs by the LLM is ensured.

In S2, bridging a gap between in-domain vulnerability localization and out-of-domain vulnerability localization using an out-of-distribution detection algorithm; wherein in an inference phase, the tool for vulnerability localization employs an out-of-distribution detector configured to evaluate whether the vulnerability falls within a known distribution range of a fine-tuned model, i.e., whether the vulnerability is an in-distribution vulnerability; the out-of-distribution detector analyzes and evaluates enhanced line-level representations obtained previously from a fine-tuning training dataset using a K-nearest neighbor algorithm; based on an evaluation result, the tool for vulnerability localization is configured to perform prediction using an enhanced fine-tuned model or perform prediction using a pretrained LLM.

The out-of-distribution detector is configured to perform out-of-distribution detection on a code snippet to determine whether the code snippet belongs to out-of-distribution data (out-of-domain data). In the present disclosure, the out-of-distribution detector may also be referred to as an out-of-domain data detector. In some embodiments, the out-of-distribution detector may integrate an algorithm module to implement detection of the out-of-distribution data.

The out-of-distribution detection algorithm refers to an algorithm used to determine whether a code snippet belongs to the out-of-domain data. In some embodiments, the out-of-distribution detection algorithm may be the K-nearest neighbor algorithm.

The fine-tuned model refers to an LLM after fine-tuning. In some embodiments, the fine-tuned model may be obtained by performing further training on the pre-trained LLM using the fine-tuning training dataset.

In some embodiments, a processing device may obtain a plurality of training samples with labels to constitute the fine-tuning training dataset and perform a plurality of iterations based on the fine-tuning training dataset. The training samples include sample code snippets, and the labels corresponding to the training samples are sample vulnerability positions corresponding to the sample code snippets. In some embodiments, the training samples may come from public or private code repositories, and the processing device may determine the labels corresponding to the training samples based on historical fix patches. For example, by comparing differences between a vulnerable version and a fixed version, code lines related to the vulnerability are determined as vulnerability position labels. In some embodiments, the processing device may divide the plurality of training samples into a plurality of fine-tuning training datasets.

At least one of the plurality of iterations includes: selecting one or more training samples from the fine-tuning training dataset; inputting the one or more training samples into an initial LLM (e.g., the pre-trained LLM) to obtain model outputs corresponding to the one or more training samples; substituting the model outputs corresponding to the one or more training samples and labels corresponding to the one or more training samples into a formula of a predefined loss function to calculate a value of the loss function; iteratively updating model parameters in the initial large language model according to the value of the loss function until an iteration termination condition is satisfied, ending the iteration, and obtaining a trained fine-tuned model.

The known distribution range of the fine-tuned model refers to a feature distribution formed by samples in the fine-tuning training dataset. In some embodiments, in response to a vulnerability function to be detected falling within the known distribution range, the vulnerability function is determined to belong to the known distribution range, and the vulnerability function is determined as the in-distribution data; otherwise, the vulnerability function is determined as the out-of-distribution data. In the present disclosure, the in-distribution data may also be referred to as the in-domain data or the in-distribution vulnerability, the out-of-distribution data may also be referred to as the out-of-domain data, and the known distribution range of the fine-tuned model may also be referred to as a knowledge boundary of the fine-tuned model.

In the present disclosure, evaluating in whether the vulnerability belongs to the known distribution range of the fine-tuned model in the operation S2 primarily aims to identify code snippets beyond the known distribution range and determine the out-of-domain data. The evaluation process may also be referred to as an out-of-distribution (OOD) detection manner (hereinafter referred to as the OOD detection manner) to avoid false positives by the fine-tuned model when facing the out-of-domain data beyond the known distribution range. The OOD detection manner differs from traditional manners. Traditional manners typically rely on final output features of the LLM for out-of-distribution detection, whereas the tool for vulnerability localization in the present disclosure comprehensively utilizes outputs of the LLM and aggregated line-level features to detect OOD samples (hereinafter referred to as out-of-domain samples) when performing out-of-distribution detection. Since the LLM is pre-trained on a large corpus of source code, the outputs of the LLM may capture broader semantic information of code, and the aggregated line-level features contain more features related to specific vulnerabilities. Therefore, the tool for vulnerability localization can capture information in code from a plurality of levels and better identify out-of-domain samples. The out-of-domain samples refer to vulnerability functions of the out-of-domain data and corresponding code snippets.

In some embodiments, during a training phase, the tool for vulnerability localization may determine a distribution of the “in-domain data” based on the fine-tuning training dataset and use the distribution as the known distribution range of the fine-tuned model.

Specifically, for a feature representation (i.e., the hidden state) of each statement (i.e., each line of code) generated by the LLM, the tool for vulnerability localization may generate a feature vector representing the statement by calculating an average of feature representations of each token. The average of the feature representations of each token not only retains a maximum amount of information but also ensures that the feature vector of the statement has a consistent shape with aggregated line-level features, facilitating subsequent comparison between the feature vector and the aggregated line-level features. Next, the tool for vulnerability localization may perform normalization processing on each feature vector to determine a normalized feature vector for each line of code; based on the normalized feature vectors, the tool for vulnerability localization may determine a distribution of “the in-domain data” corresponding to the fine-tuning training data, and use the distribution as the known distribution range of the fine-tuned model.

In some embodiments, during a test phase, the tool for vulnerability localization may use the K-nearest neighbor (KNN) algorithm to determine whether a given code snippet belongs to the out-of-domain data. The given code snippet may be a code line most likely to cause a vulnerability in test data. The code line may be preset based on historical data or prior knowledge, e.g., preset to code lines containing high-risk API calls, missing boundary checks, or user input involved in critical operations. The test data refers to a code line or code snippet to be analyzed, which may be preset by an IT developer according to requirements. The test phase refers to a phase in a software development lifecycle where operations S1-S3 are performed on a source code file to determine a vulnerability localization result before deployment of the source code.

The specific process is as follows: the tool for vulnerability localization may select lines of code that are most likely to cause vulnerabilities from the test data based on historical data or prior knowledge, and use the lines of code as code snippets of the test data; extract feature vectors of the code snippets in the test data; perform normalization processing on the feature vectors to determine normalized feature vectors of the code snippets; then the tool for vulnerability localization may calculate distances between the normalized feature vectors of a target code line and a plurality of normalized feature vectors within the distribution (i.e., the known distribution range) of “in-domain data” in the fine-tuning training dataset; sort the distances in an ascending order; based on a preset K value, select top K normalized feature vectors with smallest distances from sorted results as the K nearest neighbor vectors that are closest to the code snippets of the test data; in response to a maximum distance among the K nearest neighbor vectors exceeds a preset threshold (i.e., 2), determine the code snippets corresponding to the target code line as the out-of-domain data; in response to the maximum distance among the K nearest neighbor vectors does not exceed the preset threshold A, determine the code snippets of the test data as the in-domain data. The preset threshold 2 may be preset based on historical data or prior knowledge.

In some embodiments of the present disclosure, using the K-nearest neighbor algorithm during the test phase to perform out-of-domain data detection on the code line most likely to cause the vulnerability can improve the targeting of the detection of the out-of-domain data. In response to the feature vectors of the code snippets of the test data being identified as the out-of-domain data, a corresponding vulnerability function may be inferred to be an unseen and unknown code type to the fine-tuned model, thereby avoiding false positives by the fine-tuned model on unknown inputs (i.e., the unseen and unknown code type). In this way, the tool for vulnerability localization can effectively detect code snippets that do not belong to the known distribution range, avoiding overfitting or false positives by the fine-tuned model when facing the out-of-domain data, thereby improving the accuracy and robustness of vulnerability detection.

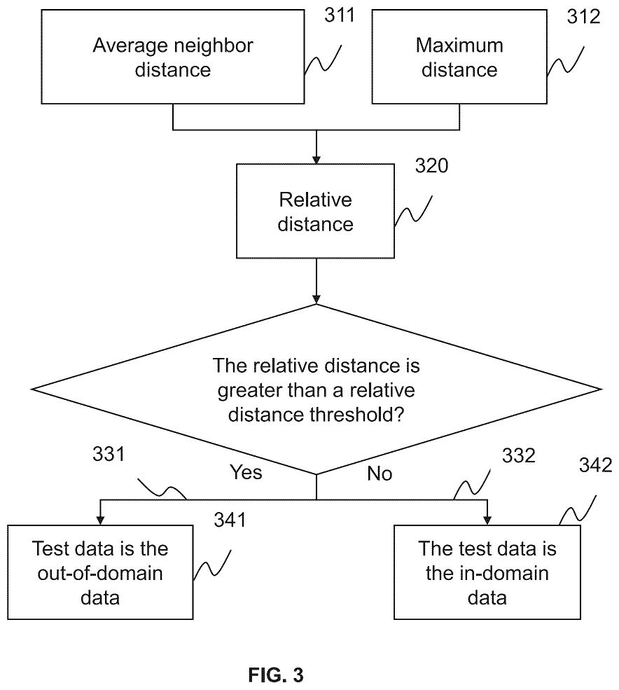

FIG. 3 is a schematic diagram illustrating an exemplary process for determining whether a code snippet corresponding to test data is in-domain data or out-of-domain data according to some embodiments of the present disclosure.

In some embodiments, as shown in FIG. 3, the operation S2 further includes: determining a relative distance 320 of test data based on an average neighbor distance 311 and a maximum distance 312 of K nearest neighbor vectors; in response to the relative distance being greater than a relative distance threshold 331, determining that the code snippet corresponding to the test data is the out-of-domain data 341; in response to the relative distance being less than or equal to the relative distance threshold 332, determining that the code snippet corresponding to the test data is the in-domain data 342.

The neighbor distance refers to a distance value within a set of K nearest neighbor vectors used to characterize a closeness degree between nearest neighbor vectors. For example, a smaller neighbor distance indicates that the nearest neighbor vector is closer to other K−1 nearest neighbor vectors within the set of K nearest neighbor vectors.

In some embodiments, for any nearest neighbor vector in the set of K nearest neighbor vectors, the processing device may calculate Euclidean distances between the nearest neighbor vector and the other K−1 nearest neighbor vectors in the set and determine a minimum Euclidean distance among the Euclidean distances as a neighbor distance of the nearest neighbor vector, thereby obtaining K neighbor distance values corresponding to K nearest neighbor vectors in the set of K nearest neighbor vectors.

The average neighbor distance refers to an average of the K neighbor distances corresponding to the K nearest neighbor vectors.

The relative distance refers to a relative deviation degree of a distance from a feature vector of the code snippet corresponding to the test data to the set of K nearest neighbor vectors relative to the average neighbor distance. For example, a larger relative distance indicates that the feature vector of the code snippet corresponding to the test data is more deviated relative to the set of K nearest neighbor vectors, and the code snippet corresponding to the test data is more likely to be beyond the known distribution range of the fine-tuned model.

In some embodiments, the processing device may use a ratio of the maximum distance among the K nearest neighbor vectors to the average neighbor distance as the relative distance. Merely by way of example, the relative distance=the maximum distance/the average neighbor distance.

In some embodiments, in response to a determination that the relative distance is greater than the relative distance threshold, it is determined that the feature vector of the code snippet corresponding to the test data is relatively far from the set of K nearest neighbor vectors, and vectors within the set of K nearest neighbor vectors are relatively close, thereby indicating that the feature vector of the code snippet corresponding the test data significantly deviates from an existing distribution range of the fine-tuned model relative to neighbor vectors in the set of K nearest neighbor vectors, and it is determined that the code snippet corresponding to the test data is the out-of-domain data. The relative distance threshold may be preset based on statistical analysis of historical data or prior knowledge. For example, a maximum relative distance that causes a proportion of historical in-domain data being misjudged as the out-of-domain data to be lower than a safety upper limit (e.g., 2%) may be selected as the relative distance threshold.

In some embodiments, in response to a determination that the relative distance is less than or equal to the relative distance threshold, it is indicated that a deviation degree of the feature vector of the code snippet corresponding to the test data relative to the set of K nearest neighbor vectors does not exceed the relative distance threshold, thereby indicating that the feature vector of the code snippet corresponding to the test data is relatively consistent with a feature distribution of the set of K nearest neighbor vectors, and it is determined that the code snippet corresponding to the test data is the in-domain data.

In some embodiments of the present disclosure, by determining the relative distance of the test data, and determining whether the code snippet corresponding to the test data is the out-of-domain data based on the relative distance threshold and the relative distance, measurement of the deviation degree of the test data can be adapted to feature density differences of the set of K nearest neighbor vectors under different programming languages or different code structures/coding styles, and adaptation capability and stability in different application scenarios such as cross-language, cross-project, and cross-code style are improved, and accuracy of the in-domain data and the out-of-domain data detection is improved.

The evaluation result is used to indicate whether a vulnerability to be detected belongs to the known distribution range of the fine-tuned model. For example, the evaluation result may indicate that a vulnerability function belongs to the known distribution range, and the vulnerability function is determined to be an in-distribution vulnerability (i.e., the in-domain data); or the evaluation result may indicate that the vulnerability function does not belong to the known distribution range.

In S3, making decisions on in-distribution data and out-of-distribution data; wherein in response to the vulnerability function falling within the known distribution range, the tool for vulnerability localization is configured to assign the in-distribution data to the fine-tuned model for processing, and finally generate a vulnerability probability for each line of code; otherwise, for out-of-distribution data, the tool for vulnerability localization is configured to perform inference using the LLM combined with a chain-of-thought (CoT).

The vulnerability probability refers to a probability value that a line of code contains the vulnerability.

In some embodiments, the operation S3 is used to apply the LLm to the vulnerability localization of the in-domain data and the out-of-domain data according to the evaluation result of the operation S2, thereby improving accuracy of a vulnerability localization result. The operation S3 may include: domain discrimination, in-domain localization, and out-of-domain localization.

The domain discrimination refers to determining whether a vulnerability sample exceeds the known distribution range of the fine-tuned model.

The fine-tuned model of the present disclosure is enhanced through an information aggregator and a syntax highlighter, but due to a limited scale of the fine-tuning training dataset, an applicable scope of the fine-tuned model in practical applications is limited to the known distribution range corresponding to the fine-tuning training dataset. Although the fine-tuned model has certain generalization capability, knowledge mastered by the fine-tuned model is still limited to a known distribution in a training set, and false positives may still occur for the out-of-domain data beyond the known distribution range. Therefore, the OOD detection manner of the operation S2 in the present disclosure can obtain an evaluation result of in-domain/out-of-domain determination.

In some embodiments, the tool for vulnerability localization may perform the domain discrimination based on the evaluation result output by the operation S2 to determine whether the vulnerability sample belongs to the out-of-domain data. Specifically, in response to a distance of the vulnerability sample exceeds a preset threshold A, it indicates that the vulnerability sample is beyond the knowledge boundary of the fine-tuned model, and thus the vulnerability sample belongs to the out-of-domain data. Due to limited generalization capability of the fine-tuned model for the out-of-domain data, the fine-tuned model has difficulty in making accurate localization judgments. Therefore, the vulnerability sample may be submitted to the pre-trained LLM for further processing and the vulnerability localization.

Although the pre-trained LLM is not specifically trained for a particular vulnerability type, as a general-purpose model, the LLM is pre-trained on a large amount of source code, possesses a large amount of code knowledge, and can handle the vulnerability samples that do not belong to the distribution range of the fine-tuned model to a certain extent. In addition, the LLM may apply zero-shot learning capability to analyze new types of vulnerabilities.

The in-domain localization refers to the tool for vulnerability localization using an enhanced fine-tuned model to perform the vulnerability localization on the in-domain data.

The enhanced fine-tuned model refers to a fine-tuned model that combines the information aggregator and the syntax highlighter to enhance a feature representation corresponding to the source code. In some embodiments, based on the fine-tuned model, the information aggregator and the syntax highlighter may be introduced to enhance the feature representation of the training sample, and the fine-tuning training dataset may be used to perform a plurality of iterations to obtain the enhanced fine-tuned model. More descriptions regarding the fine-tuning training dataset and the fine-tuned model may be found in the operation S2 and the related descriptions thereof.

At least one of the plurality of iterations includes: selecting one or more training samples from the fine-tuning training dataset, inputting the one or more training samples into the fine-tuned model to obtain model outputs corresponding to the one or more training samples; substituting the model outputs corresponding to the one or more training samples and labels corresponding to the one or more training samples into a formula of a predefined loss function to calculate a value of the loss function; and iteratively updating model parameters in an initial large language model according to the value of the loss function until an iteration termination condition is satisfied, ending the iteration, and obtaining a trained enhanced fine-tuned model.

In some embodiments, since the in-domain data belongs to the knowledge boundary of the fine-tuned model, the tool for vulnerability localization may perform the vulnerability localization based on the enhanced fine-tuned model. Specifically, the tool for vulnerability localization may generate a probability value containing a possibility of a vulnerability for each line of code in the source code, arrange each line of code in a descending order according to the probability value, and select top N lines as locations most likely to have vulnerabilities as the vulnerability localization result. Through the above probability-based sorting method, the fine-tuned model can focus on code lines with higher vulnerability probabilities, thereby improving the accuracy of the vulnerability localization and improving the efficiency of the vulnerability localization.

The out-of-domain localization refers to the tool for vulnerability localization using the pre-trained large language model to perform the vulnerability localization on the out-of-domain data.

In some embodiments, in response to a determination that the vulnerability sample is determined to be the out-of-domain data, the tool for vulnerability localization may use a CoT prompting technique to guide the LLM to think and analyze the source code, thereby locating the vulnerability.

Specifically, first, the tool for vulnerability localization may first provide an initial prompt to the LLM to activate vulnerability identification capability of the LLM, allowing the LLM to focus on vulnerability-related code features; then, the tool for vulnerability localization may provide a more fine-grained prompt to the LLM, guiding the LLM to perform stepwisde thinking and analysis on the out-of-domain data, and helping the LLM further determine a vulnerability position in the vulnerability sample as the vulnerability localization result.

By adopting the CoT prompt, the LLM can analyze the location of the vulnerability step by step when facing complex code, and provide detailed vulnerability locations and reasons in a systematic manner. The CoT prompting method can not only fully utilize advantages of the LLM in understanding the semantic information of code, but also ensure that the LLM can provide a reasonable analysis process when facing new types of vulnerabilities, helping developers understand and fix problems.

As an example, the tool for vulnerability localization may provide an initial prompt to the LLM: “You are an expert in the field of vulnerabilities, capable of understanding deep semantic information of programs.” This step aims to activate the vulnerability identification capability of the LLM, allowing the LLM to focus on vulnerability-related code features in the code snippet. Then, the tool for vulnerability localization may design the more fine-grained prompt for the LLM to help the LLM further refine the vulnerability localization process. Content of the more fine-grained prompt is roughly as follows: “Analyze security vulnerabilities in the provided code snippet and responded with a JSON object. The object should contain two keys: ‘Functionality’ (describing functionality of the code) and ‘Vulnerable Positions’ (a list containing five JSON objects). Each object in ‘Vulnerable Positions’ should contain ‘lineNumber’ (showing a line where a potential problem is located) and ‘reason’ (detailing why that part of the code is considered vulnerable). Think step by step.” The LLM can execute, based on instructions of the prompt, a multi-step logical inference process (i.e., think step by step), and finally generate a structured response conforming to a predetermined JSON object format as the vulnerability localization result.

In some embodiments of the present disclosure, the tool for vulnerability localization can effectively distinguish between in-domain and out-of-domain vulnerability samples (i.e., the in-domain data and the out-of-domain data) through the domain discrimination, the in-domain localization, and the out-of-domain localization, and adopt different processing strategies for different types of data. For the in-domain data, the tool for vulnerability localization can use the enhanced fine-tuned model for efficient vulnerability localization; for the out-of-domain data, the tool for vulnerability localization relies on zero-shot learning capability of the pre-trained LLM, and guides the LLM to analyze the vulnerability step by step through the CoT prompting technique. Through the above methods, the LLM is ensured to maintain high localization efficiency and localization accuracy when handling known and unknown vulnerabilities, significantly improving the model's ability to handle unknown vulnerability types and detection coverage of new vulnerabilities, and significantly reducing the risks of false positives and false negatives brought by the out-of-domain data.

In some embodiments of the present disclosure, by utilizing the information aggregator to aggregate all code element information of a single line of code; and by utilizing the syntax highlighter to highlight the key code elements directly related to the vulnerability, expressive capability for vulnerability semantic features at a line-level granularity is enhanced, interference of unrelated code elements on the localization result is reduced, and accuracy and stability of the vulnerability localization are improved; through the decisive feature selection and the decisive token selection, the decisive features and the decisive tokens directly related to the vulnerability can be selected, suppressing influence of spurious features and noise features, thereby improving the accuracy of the vulnerability localization. The adaptive domain mask mechanism is utilized to effectively filter redundant information, reducing false positives and misjudgments; for the in-domain data, the enhanced fine-tuned model is used for processing to achieve efficient and stable vulnerability localization within the known distribution range; for the out-of-domain data, the enhanced fine-tuned model is prevented from making unreliable inferences beyond the knowledge boundary of the enhanced fine-tuned model, and the out-of-domain data is submitted to the pre-trained LLM for inference localization, combined with the CoT prompt to output the vulnerability localization result, thereby improving processing capability for unknown vulnerability types, reducing risks of erroneous localization and untrustworthy output, and improving comprehensibility of the vulnerability localization result.

FIG. 4 is a flowchart illustrating an exemplary process for detection and deployment control of an object to be released according to some embodiments of the present disclosure. As shown in FIG. 4, a process 400 includes the following operations. In some embodiments, the process 400 may be executed by a processing device.

In 410, in response to a version control system generating an object to be released, extracting a source code file of the object to be released through the version control system.

The version control system refers to a system for managing versions of software source code files. The version control system may record a change history of the source code files, support creation of different code branches, merging of different code branches, and comparison of differences between source codes of different versions, and store source codes in a code repository. Under management of the version control system, the code repository may form different versions as the source codes are submitted, merged, or changed. The version control system may include version control tools such as Git.

The object to be released refers to a software code set that has completed development in a software development lifecycle and is ready to be integrated into a main branch or deployed to a production environment. In some embodiments, the object to be released includes a candidate code branch and an incremental code change. The main branch refers to a code branch in the code repository of the version control system for carrying mainline code. The production environment refers to a runtime environment where software code is deployed and runs. More descriptions regarding the test phase may be found in the operation S2 in FIG. 2 and the related descriptions thereof.

The candidate code branch refers to a complete code branch separated from a main development branch for pre-release verification. The candidate code branch may include code sets for a plurality of new features.

The incremental code change refers to a set of code differences generated relative to an existing version of the code repository. The set of code differences is used to characterize added, modified, and/or deleted code content. Merely by way of example, the incremental code change may include code differences corresponding to a single commit, code differences to be merged introduced by a pull request, code differences provided as a patch, or a change set formed by summarizing a plurality of code changes.

In some embodiments, the processing device may use a complete code branch separated from the main branch as the candidate code branch.

In some embodiments, the processing device may obtain the incremental code change by comparing different versions with the existing version of the code repository through the version control tool (e.g., Git) in the version control system.

The source code file of the object to be released refers to a program source file parsed from the object to be released. Merely by way of example, the source code file may include source files written in programming languages such as Java, Python, and C/C++.

In some embodiments, the processing device may extract the source code file using a preset command provided by the version control tool in the version control system. Taking Git as an example, the preset command may include git diff, git checkout, or the like. As an example, the processing device may obtain a source code file corresponding to the candidate code branch through git checkout, or obtain code differences corresponding to the incremental code change through git diff, and determine the source code file based on the incremental code change.

In some embodiments, in response to the version control system not generating the object to be released, the processing device may not perform extraction of the source code file and the vulnerability localization.

In 420, performing operations S1-S3 based on the source code file to determine a vulnerability localization result of the object to be released.

The vulnerability localization result refers to information characterizing a potential vulnerability of the object to be released. Merely by way of example, for the in-domain data, the vulnerability localization result may include a code line number where the potential vulnerability is located in the source code, a vulnerability type (e.g., SQL injection and buffer overflow), and a vulnerability probability. For the out-of-domain data, the vulnerability localization result may include a code line number where the potential vulnerability is located in the source code, and a judgment reason corresponding to the vulnerability localization result.

More descriptions regarding the vulnerability probability may be found in the operation S3 in FIG. 2 and the related descriptions thereof. The judgment reason refers to explanatory information output by the LLM for the vulnerability localization result. The judgment reason may include a plurality of semantic keywords. Merely by way of example, the semantic keywords of the judgment reason may point out risk bases related to the potential vulnerability, such as unvalidated input, sensitive information leakage, missing boundary checks, dangerous function calls, or improper parameter concatenation.

In some embodiments, the processing device may perform the operations S1-S3 on the source code corresponding to the object to be released to determine the vulnerability localization result of the object to be released. More descriptions regarding how to determine the vulnerability localization result may be found in FIG. 2 and the related descriptions thereof, which are not repeated herein.

In some embodiments, the processing device may perform operation 431 and operation 432 to determine whether to deploy the object to be released to a first server or control an alarm device to issue an alarm.

In 431, in response to the vulnerability localization result satisfying a first preset condition, deploying the object to be released to a first server.

The first preset condition refers to a determination condition characterizing that the object to be released is in a low-risk state. In some embodiments, satisfying the first preset condition may include at least one of the following: the vulnerability probability in the vulnerability localization result is less than a first security threshold, or an inference risk reflected by a judgment reason corresponding to the vulnerability localization result is low. The first security threshold may be set based on experience, e.g., 30%.

The inference risk reflected by the judgment reason refers to a harm intensity of a security problem that the code snippet may cause after the potential vulnerability reflected by the judgment reason of the vulnerability localization result is exploited.

In some embodiments, the processing device may determine the inference risk of the judgment reason based on semantic keywords in the judgment reason and a first cluster through a clustering algorithm. The first cluster is a high-risk cluster, and the first cluster may be pre-constructed based on historical high-risk samples.

In some embodiments, the processing device may extract semantic features for characterizing a risk of the potential vulnerability based on semantic keywords (e.g., “unvalidated input”, and “sensitive information leakage”) in the judgment reason. The processing device may construct a current embedding vector based on the semantic features, code function information, and a vulnerability location list. The processing device may calculate a distance between the current embedding vector and the first cluster through a clustering algorithm. In response to the distance being less than a similarity threshold, or the current embedding vector being assigned to the first cluster, the processing device may determine that the inference risk of the judgment reason is high. In response to the distance being greater than the similarity threshold, the processing device may determine that the inference risk of the judgment reason is low. The clustering algorithm includes, but is not limited to, a K-Means clustering algorithm, etc. The similarity threshold may be set based on experience.

The code function information is used to characterize a functional module (e.g., a login module, and a payment module) to which a code snippet belongs in the object to be released. The code function information may be determined based on at least one of module affiliation of the object to be released and a code tag. The vulnerability location list is a list of suspicious vulnerability locations output in the vulnerability localization result. The vulnerability location list may be formed based on the code line number where the vulnerability is located in the vulnerability localization result.

The first server refers to a computing device for deploying and running the object to be released. In some embodiments, the first server may be preset based on historical data or prior knowledge. Merely by way of example, an address of the first server may be preset in a configuration file.

In some embodiments, in response to the vulnerability localization result satisfying the first preset condition, the processing device may parse the address of the first server recorded in the configuration file and deploy the object to be released to the first server.

In some embodiments, in response to the vulnerability localization result satisfying the first preset condition, the processing device may determine, from at least one second server, the first server corresponding to the object to be released based on at least one of a branch name, the module affiliation, and the code tag of the object to be released, and deploy the object to be released to the first server. More descriptions regarding the second server may be found in FIG. 5 and the related descriptions thereof.

In 432, in response to the vulnerability localization result not satisfying the first preset condition, controlling an alarm device to issue an alarm.

The alarm device refers to an operation and maintenance terminal device configured to output vulnerability alarm information. For example, the alarm device may be an operation and maintenance display device (e.g., a monitoring large screen), an operation and maintenance terminal (e.g., a mobile terminal of a security administrator), or the like.

In some embodiments, in response to the vulnerability localization result not satisfying the first preset condition, the processing device may generate alarm information based on the vulnerability localization result. The alarm information may include a file name of the object to be released, a line number where the vulnerability is located, the vulnerability probability, the judgment reason, or the like. The processing device may push the alarm information to the alarm device to display the alarm information.

In some embodiments of the present disclosure, by determining whether the vulnerability localization result satisfies the first preset condition and taking corresponding measures respectively, the vulnerability localization result can be associated with a software deployment process, enabling localization and evaluation of the potential vulnerability to be completed before the object to be released is deployed to the first server. In this way, the object to be released with a higher security risk can be prevented from entering the first server, thereby improving the security and controllability of the software release process.

FIG. 5 is a flowchart illustrating an exemplary process for determining clean traffic according to some embodiments of the present disclosure. As shown in FIG. 5, a process 500 includes the following operations. In some embodiments, the process 500 may be implemented by a processing device, at least one second server, a switch in communication connection with the at least one second server, and a field-programmable gate array (FPGA) cleaning card in communication connection with the switch.

The at least one second server refers to a computing device that has deployed and is running software code. In some embodiments, the at least one second server has a port for network communication. Merely by way of example, the port may include a port for providing service access, a port for management access, a network listening port, or the like. The at least one second server may be a single server, a server group composed of a plurality of servers, or the like. The server group may be centralized or distributed.

The switch refers to a network device configured to forward data traffic within a network. In some embodiments, the switch may be in communication connection with the port of the at least one second server via the network. The switch is configured to forward data packets between the at least one second server and an external network.

The FPGA cleaning card refers to a device for filtering network traffic based on the FPGA. In some embodiments, the switch may be in communication connection with the FPGA cleaning card via the network. The FPGA cleaning card is configured to receive network traffic diverted by the switch and forward filtered clean traffic back to the server.

In 510, periodically extracting a source code file corresponding to deployed running code through at least one second server.

The deployed running code refers to code that has been deployed to the at least one second server and is in a running state.

In some embodiments, the processing device may, through the at least one second server, use a preset command provided by a version control tool in a version control system to periodically extract the source code file corresponding to the deployed running code. A period for periodically extracting may be a preset time period (e.g., every 24 hours). More descriptions regarding how to extract the source code file may be found in the operation 410 in FIG. 4 and the related descriptions thereof.

In 520, performing operations S1-S3 based on the source code file to determine a vulnerability localization result of the deployed running code. More descriptions regarding how to determine the vulnerability localization result may be found in FIG. 2 and the related descriptions thereof, which are not repeated here.

In 530, in response to the vulnerability localization result satisfying a second preset condition, determining a target blocking port of the at least one second server where the deployed running code is located based on the vulnerability localization result.

The second preset condition refers to a determination condition characterizing that the deployed running code in the second server is in an extremely high-risk state and requires immediate port blocking. In some embodiments, satisfying the second preset condition may include at least one of the following: a vulnerability probability in the vulnerability localization result is greater than or equal to a second security threshold, or a judgment reason of the vulnerability localization result reflects a high inference risk. More descriptions regarding the inference risk of the judgment reason may be found in the operation 431 in FIG. 4 and the related descriptions thereof.

The second security threshold may be preset to be greater than the first security threshold, reflecting that taking port blocking for the deployed running code has a higher impact cost compared to withdrawing the object to be released. Merely by way of example, the first security threshold may be set to 30%, and the second security threshold may be set to 90%.

The target blocking port refers to a network listening port in the second server that needs to be blocked and have traffic diverted. Merely by way of example, the target blocking port may be a network listening port (e.g., TCP port 8080) through which a functional module corresponding to the deployed running code provides services externally.

In some embodiments, in response to the vulnerability localization result satisfying the second preset condition, the processing device may parse a code line number in the vulnerability localization result based on the vulnerability localization result, and identify a functional module to which code corresponding to the code line number belongs. The processing device may determine a network listening port through which the functional module provides services externally by querying a comparison table, and determine the network listening port as the target blocking port. The comparison table may include correspondence relationships between a plurality of functional modules and a plurality of network listening ports. The comparison table may be pre-constructed and periodically updated based on historical deployment records in the code repository or prior knowledge. The historical deployment records include correspondence relationships between functional modules corresponding to historical deployed running code and network listening ports.

In 540, performing port blocking on the target blocking port through a switch, and redirecting traffic destined for the target blocking port to an FPGA cleaning card.

The performing port blocking on the target blocking port refers to an operation of cutting off a communication path to the target blocking port of the second server to prevent external traffic from entering the target blocking port of the second server via the network.

In some embodiments, the processing device may issue an access control list (ACL) instruction to the switch connected to the second server to block external traffic from entering the target blocking port of the second server. Meanwhile, the processing device may control the switch to forward network traffic of the target blocking port to the FPGA cleaning card. Merely by way of example, the processing device may block the port 8080 and retain a port for remote management to allow manual intervention.

In 550, filtering, through the FPGA cleaning card, a data packet satisfying a vulnerability trigger feature to determine filtered clean traffic, and forwarding the clean traffic back to the at least one second server.

The data packet is a basic data unit transmitted during network communication.

The vulnerability trigger feature refers to a data feature that may trigger a potential vulnerability in a code snippet to induce abnormal execution or causing a security issue. In some embodiments, the vulnerability trigger feature may include a specific character sequence pattern for an SQL injection vulnerability, an overly long string for a buffer overflow vulnerability, a specific malicious instruction sequence for a remote code execution vulnerability (e.g., a command snippet represented by a hexadecimal byte sequence), or the like.

In some embodiments, the processing device may send a route update instruction to a network device (e.g., the switch or a hardware gateway) to cause network traffic originally flowing to the target blocking port to be redirected and diverted to the FPGA cleaning card. The FPGA cleaning card filters out data packets in the network traffic that match the vulnerability trigger feature to obtain clean traffic, and forwards the cleaned clean traffic back to the second server. The route update instruction refers to an instruction for modifying a network traffic forwarding path. The clean traffic refers to network traffic composed of data packets obtained after filtering by the FPGA cleaning card.

In some embodiments, in response to the vulnerability localization result not satisfying the second preset condition, the processing device may not perform port blocking on the target blocking port. The deployed running code may undergo subsequent handling without affecting the current operation. Merely by way of example, the subsequent handling may include, but is not limited to, manual review of the deployed running code, code repair in a subsequent maintenance cycle, or submission of repaired code changes through the version control system.

In some embodiments of the present disclosure, by periodically extracting the source code file corresponding to the deployed running code and executing the operations S1-S3 to determine the vulnerability localization result of the deployed running code, potential vulnerabilities and risk changes can be continuously perceived after the program goes online and runs. This continuous perception avoids relying solely on pre-release detection, which may cause security risks of newly added vulnerabilities during code runtime or environmental changes to be overlooked, thereby improving coverage and timeliness of security detection during code runtime. By performing port blocking on the target blocking port and filtering data packets that match the vulnerability trigger feature, proactive defensive measures can be actively taken when an extremely high-risk state is detected, rather than only performing passive alarms or manual intervention. In this way, proactive defense capability and overall controllability of software code in the face of high-risk vulnerabilities during the runtime can be significantly improved.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A large language model (LLM)-based method for vulnerability localization, comprising: using a tool for vulnerability localization, wherein the tool for vulnerability localization includes: an information aggregator and a syntax highlighter configured to enhance vulnerability localization, and an algorithm module configured to detect out-of-distribution data;
the method comprises:
S1, enhancing the vulnerability localization using the information aggregator and the syntax highlighter; wherein firstly, the tool for vulnerability localization inputs a source code after tokenization into an LLM to extract a hidden state containing semantic information; then the information aggregator is configured to integrate all code element information of a single line of code in the source code, and the syntax highlighter is configured to highlight key code elements in the single line of code to determine whether the single line of code contains a vulnerability;
S2, bridging a gap between in-domain vulnerability localization and out-of-domain vulnerability localization using an out-of-distribution detection algorithm; wherein in an inference phase, the tool for vulnerability localization employs an out-of-distribution detector configured to evaluate whether the vulnerability falls within a known distribution range of a fine-tuned model, to determine whether the vulnerability is an in-distribution vulnerability; the out-of-distribution detector analyzes and evaluates enhanced line-level representations obtained previously from a fine-tuning training dataset using a K-nearest neighbor algorithm; based on the evaluation result, the tool for vulnerability localization is configured to perform prediction using an enhanced fine-tuned model or perform prediction using a pretrained LLM; and
S3, making decisions on in-distribution data and the out-of-distribution data; wherein in response to a vulnerability function falling within the known distribution range, the tool for vulnerability localization is configured to assign the in-distribution data to the fine-tuned model for processing, and finally generate a vulnerability probability for each line of code; otherwise, for the out-of-distribution data, the tool for vulnerability localization is configured to perform inference using the LLM combined with a chain-of-thought (CoT).

2. The LLM-based method of claim 1, wherein the S1 includes:
firstly, using an aggregator module to perform line-level aggregation on code features to obtain a deep semantic representation of each line of code; wherein the aggregator consists of an intra-statement encoder and an inter-statement encoder; wherein the intra-statement encoder is configured to capture dependency relationships among a plurality of code elements within a code line and integrate the dependency relationships among the plurality of code elements into an enhanced line-level representation; the inter-statement encoder is configured to process contextual dependencies between different lines of code to ensure that cross-line semantic information is effectively captured;
an aggregation process of the tool for vulnerability localization includes three steps:
(1) source code tokenization and hidden state extraction: the tool for vulnerability localization firstly performs tokenization on a piece of source code corresponding to a vulnerability function, and then inputs tokens after tokenization into the LLM to generate hidden states; to extract most representative code features, the tool for vulnerability localization selects to extract hidden states corresponding to a plurality of tokens from a penultimate layer of the LLM; an objective is to extract hidden states of all tokens in each line of code from the LLM and perform unified processing: for each line of code, a maximum of 64 tokens are retained, and any line of code with fewer than 64 tokens is padded to ensure that a feature length of each line of code is consistent;
(2) line-level and cross-line feature aggregation: after preliminary features of each line of code are obtained, the tool for vulnerability localization performs feature aggregation using the aggregator; firstly, dependency relationships among a plurality of code elements within each line of code are captured using the intra-statement encoder and an enhanced line-level representation is generated; then dependency relationships between different lines of code are captured using the inter-statement encoder; and
(3) contextual aggregation and generation of a final line-level representation: finally, the tool for vulnerability localization further aggregates cross-line contextual information using a Transformer layer, and simultaneously captures forward dependency relationships and backward dependency relationships in the source code using a bidirectional attention mechanism to overcome a limitation of causal attention in the LLM; after the Transformer layer completes encoding, the tool for vulnerability localization performs average pooling on features of each line of code to generate the final line-level representation, wherein the final line-level representation provides deep semantic information of each line of code, and is ultimately used for detecting a potential vulnerability in the source code.

3. The LLM-based method of claim 1, wherein the S1 includes: filtering and highlighting tokens related to the vulnerability to reduce interference and improve accuracy of vulnerability detection; wherein
the syntax highlighter includes two operations: decisive feature selection and decisive token selection;
(1) the decisive feature selection:
the tool for vulnerability localization designs an adaptive domain mask in this phase, the adaptive domain mask being used for selecting decisive features to eliminate code elements unrelated to the vulnerability; wherein the tool for vulnerability localization applies one adaptive domain mask to a hidden state of each token, wherein the adaptive domain mask is a learnable mask for filtering out invalid features while retaining the decisive features related to the vulnerability; and after completing the decisive feature selection within each token, the tool for vulnerability localization performs further selecting among the tokens using an attention mechanism, which is operated in a token set to select most decisive tokens; and redundant and irrelevant values are removed, and a learnable adaptive domain mask is designed, and the learnable adaptive domain mask is configured to identify and prune the invalid features; wherein for the hidden state of each token, the adaptive domain mask filters out unnecessary information through adaptive learning using binary elements; the adaptive domain mask performs element-wise multiplication with feature representations of the tokens, such that zero values in the adaptive domain mask filter out spurious features in token embeddings, and non-zero values in the adaptive domain mask highlight key vulnerability-related features;
(2) the decisive token selection:
the tool for vulnerability localization processes a feature representation of each token obtained in the operation (1); wherein firstly, the hidden state of each token is used as a key vector, and a mask vector learned based on the adaptive domain mask is used as a query vector to determine an association degree between each token and the vulnerability; in this way, the tool for vulnerability localization generates an attention score for measuring connection between each token and vulnerability-related knowledge; and the attention score represents a magnitude of contribution of each token to vulnerability detection; for each vulnerability type, the tool for vulnerability localization employs a specific mask, wherein the specific mask represents a domain feature corresponding to the vulnerability type; the attention score is used for determining a contribution degree of each token to the vulnerability, and the tool for vulnerability localization determines a feature representation corresponding to a highlighted token by multiplying the attention score with the feature representation of each token, the feature representation corresponding to the highlighted token being a token feature representation directly related to the vulnerability.

4. The LLM-based method of claim 1, wherein the S2 includes: in a test phase, determining, by the tool for vulnerability localization, whether a given code snippet belongs to out-of-domain data using the K-nearest neighbor algorithm; wherein a specific process is that the tool for vulnerability localization firstly selects, from test data, a line of code most likely to cause the vulnerability and extracts features of the line of code; to implement the determination, the tool for vulnerability localization firstly determines a distance between a normalized feature vector of the line of code and “in-domain data” in a training set; then the tool for vulnerability localization sorts normalized feature vectors in an ascending order based on the distance and finds K nearest neighbor vectors closest to the given code snippet based on a preset K value; in response to a maximum distance among the K nearest neighbor vectors exceeding a preset threshold A, the given code snippet belongs to the out-of-domain data; a detection process of the out-of-domain data includes: firstly determining, in a training phase, a distribution of the in-domain data, then performing feature averaging and normalization processing such that feature vectors of the training data and the test data are directly comparable; and determining, based on the K-nearest neighbor algorithm in the test phase, a distance between a test sample and the training data, and determining whether the test sample belongs to the out-of-domain data based on the threshold.

5. The LLM-based method of claim 4, wherein the S2 further includes:
determining a relative distance of test data based on an average neighbor distance and a maximum distance of K nearest neighbor vectors;
in response to the relative distance being greater than a relative distance threshold, determining that a code snippet corresponding to the test data is the out-of-domain data;
in response to the relative distance being less than or equal to the relative distance threshold, determining that the code snippet corresponding to the test data is the in-domain data.

6. The LLM-based method of claim 1, wherein the S3 includes:
(1) domain discrimination:
determining, by calculating a distance between a vulnerability sample and data in a training set, whether the vulnerability sample belongs to out-of-domain data; in response to the distance corresponding to the vulnerability sample exceeding a preset threshold, determining that the vulnerability sample exceeds a knowledge boundary of the fine-tuned model; in such a case, providing, by the tool for vulnerability localization, detected out-of-domain samples, i.e., instances unseen by the fine-tuned model, to the pretrained LLM for further processing and vulnerability localization;
(2) in-domain localization: for in-domain data, localizing, by the tool for vulnerability localization, the vulnerability using the enhanced fine-tuned model; wherein the tool for vulnerability localization generates a probability value indicating a likelihood of the vulnerability based on each line of code in the source code, sorts probability values in a descending order, and selects top N lines as locations most likely to contain the vulnerability;
(3) out-of-domain localization: when the enhanced fine-tuned model encounters the out-of-domain data, employing, by the tool for vulnerability localization, a CoT prompting technique to guide the LLM to think and analyze the source code, thereby localizing the vulnerability; wherein the tool for vulnerability localization first activates a vulnerability identification capability of the LLM such that the LLM focuses on code features related to the vulnerability, then provides a more fine-grained prompt to the LLM to help the LLM further refine the process of vulnerability localization.

7. The LLM-based method of claim 1, wherein the LLM-based method uses a version control system to manage the source code, and the LLM-based method further comprises:
in response to the version control system generating an object to be released, extracting a source code file of the object to be released through the version control system, wherein the object to be released includes a candidate code branch and an incremental code change;
performing the operations S1-S3 based on the source code file to determine a vulnerability localization result of the object to be released;
in response to the vulnerability localization result satisfying a first preset condition, deploying the object to be released to a first server; and
in response to the vulnerability localization result not satisfying the first preset condition, controlling an alarm device to issue an alarm.

8. The LLM-based method of claim 1, wherein the LLM-based method is implemented by at least one second server, a switch in communication connection with the at least one second server, and a field-programmable gate array (FPGA) cleaning card in communication connection with the switch, and the LLM-based method further comprises:
periodically extracting a source code file corresponding to a deployed running code through the at least one second server;
performing the operations S1-S3 based on the source code file to determine a vulnerability localization result of the deployed running code;
in response to the vulnerability localization result satisfying a second preset condition, determining a target blocking port of the at least one second server where the deployed running code is located based on the vulnerability localization result;
performing port blocking on the target blocking port through the switch, and redirecting traffic destined for the target blocking port to the FPGA cleaning card; and
filtering, through the FPGA cleaning card, a data packet satisfying a vulnerability trigger feature to determine filtered clean traffic, and forwarding the filtered clean traffic back to the at least one second server.
